(19) United States
(12) Patent Application Publication
(10) Pub. No.: US 2010/0231793 A1
(43) Pub. Date: Sep. 16, 2010

(54) COMMUNICATION METHOD AND DEVICE AND TELEVISION EMPLOYING THE SAME

(75) Inventors: LUNG DAI, Tu-Cheng (TW); WANG-CHANG DUAN, Shenzhen City (CN); BANG-SHENG ZUO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/607,978

(22) Filed: Oct. 28, 2009

(30) Foreign Application Priority Data
Mar. 10, 2009 (CN) 200910300767.5

(51) Int. Cl. H04N 5/45; H04N 5/445; H04N 5/38

(52) U.S. Cl. 348/565; 348/564; 348/723; 348/738; 348/734; 348/E05.112; 348/E05.099; 348/E05.093

(57) ABSTRACT

A television includes a television signal receiving unit, a communication signal receiving unit, a processor, and a display unit. The television signal receiving unit is configured to receive TV signals. The communication signal receiving unit is configured to receive communication signals from a communication device. The processor is used for processing the TV signals to generate first video signals, and extracting second video signals from the communication signals. The display unit is used for displaying the first video signals default. When the communication signal receiving unit receives the communication signals, the processor controls the display unit to display the second video signals.

### BACKGROUND

1. Technical Field

The present disclosure relates to communication technologies, and particularly to a communication method and device.

2. Description of Related Art

Display screens of cell phones are often limited to a few square inches in size. When performing a video call, it is inconvenient for more than one person to view the video call via such a small display.

Therefore, video output seen on larger displays are desired.

### BRIEF DESCRIPTION OF THE DRAWINGS

FIG. 1 is a schematic view of a communication system in accordance with an exemplary embodiment.

FIG. 2 is a block diagram of the communication system of FIG. 1 in accordance with a first exemplary embodiment.

FIG. 3 a block diagram of the communication system of FIG. 1 in accordance with a second exemplary embodiment.

FIG. 4 is a flowchart of a communication method in accordance with an exemplary embodiment.

### DETAILED DESCRIPTION

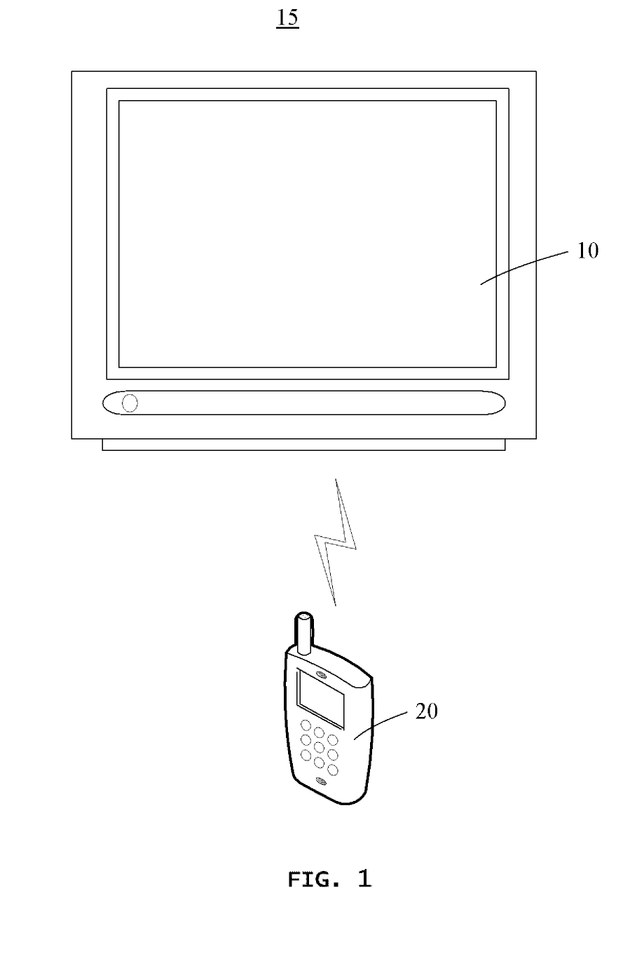

Referring to FIG. 1, a communication system 15 includes a communication device 20 and a television 10. The communication device 20 may be a cell phone, or a personal digital assistant (PDA) with communication functions and other functions. The communication device 20 can transmit video signals received from another communication device to the television 10, thus the video signals are outputted via the television 10. Because a display of the television 10 commonly has a relatively large size, it is convenient for more than one person to view pictures corresponding to the video signals.

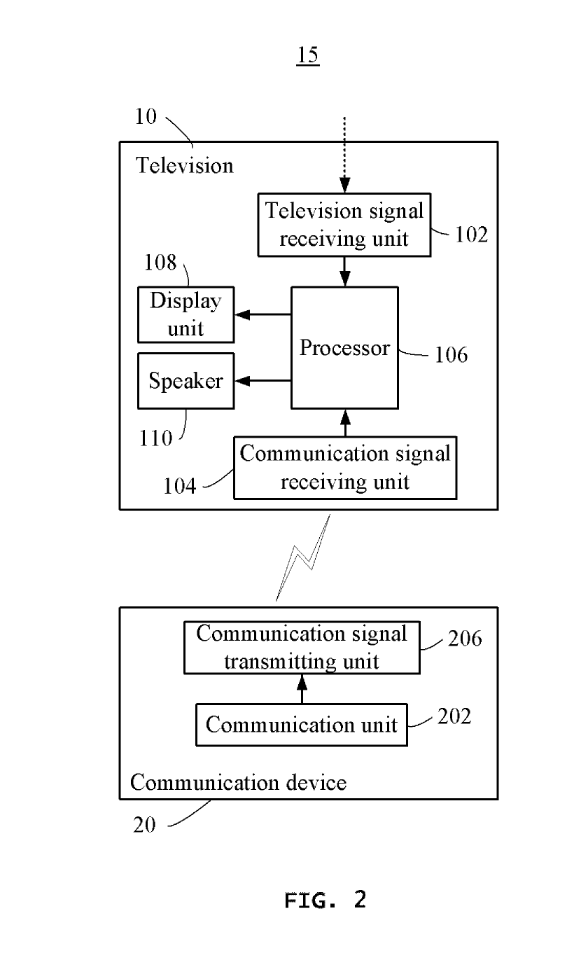

Referring to FIG. 2, the communication device 20, in accordance with a first embodiment, includes a communication unit 202, and a communication signal transmitting unit 206 connected to the communication unit 202.

The communication unit 202 is used for communicating with the another communication device, and receiving communication signals from the another communication device. The communication signals may be transmitted in a wired manner or in a wireless manner.

The communication signal transmitting unit 206 is used for transmitting the communication signals to the television 10. The communication signal transmitting unit 206 may be based on short range wireless technology, such as BLUETOOTH, WI-FI, ZIGBEE, etc.

The television 10, in accordance with the first embodiment, includes a television signal receiving unit 102, a communication signal receiving unit 104, a processor 106, a display unit 108, and a speaker 110.

The television signal receiving unit 102 is used for receiving television (TV) signals and transmitting the TV signals to the processor 10.

The communication signal receiving unit 104 is used for receiving the communication signals transmitted by the communication signal transmitting unit 206 and transmitting the communication signals to the processor 10.

The processor 106 is used for processing the TV signals to generate first video signals and first audio signals. The processor 106 is further used for extracting second video signals and second audio signals from the communication signals.

In one embodiment, the processor 106 correspondingly controls the display unit 108 and the speaker 110 to display the first video signals and reproduce the first audio signals by default. When the communication signal receiving unit 104 receives the communication signals from the communication signal transmitting unit 206, the processor 106 automatically controls the display unit 108 and the speaker 110 to display the second video signals and reproduce the second audio signals.

In other embodiment, when the communication signal receiving unit 104 receives the communication signals from the communication signal transmitting unit 206, the processor 106 controls the display unit 108 to simultaneously display the second video signals and the first video signals in the form of Picture-In-Picture (PIP) or Picture-Out-Picture (POP).

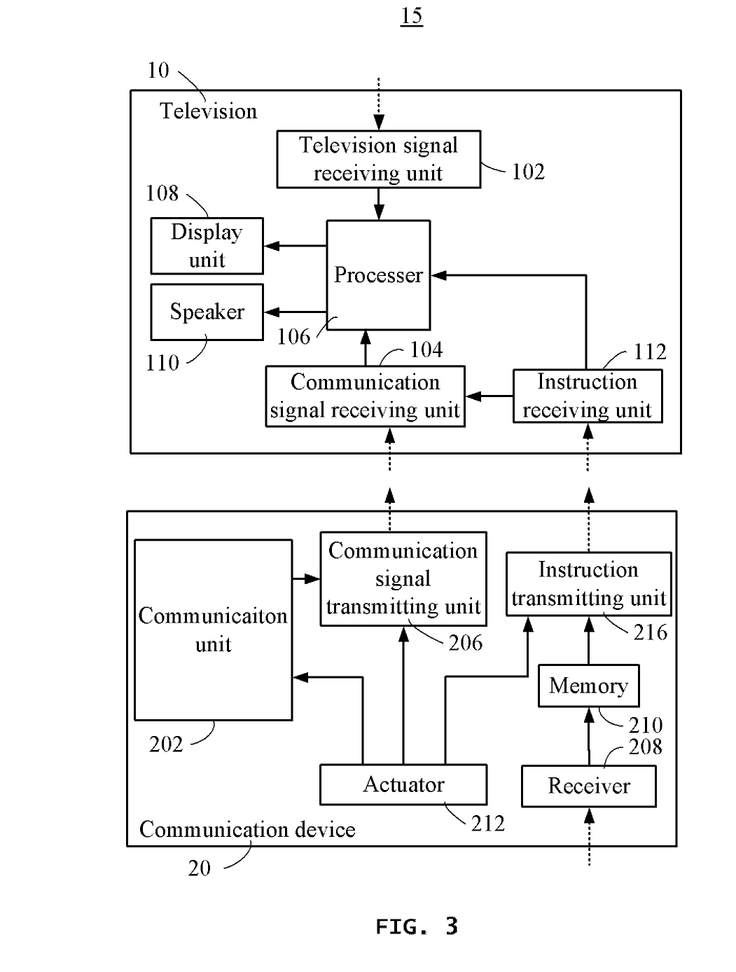

Referring to FIG. 3, a communication device 20, in accordance with a second embodiment, further includes a receiver 208, a memory 210, actuators 212, and an instruction transmitting unit 216.

The receiver 208 is adapted to communicate with a remote control. In this embodiment, the receiver 208 is used for receiving a start instruction and an end instruction transmitted from the remote control. The remote control is further adapted to control the television 10, for example, selecting a television program or adjusting a volume etc. The start instruction and the end instruction are stored in the memory 210. The receiver 208 may be an infrared receiver.

The actuators 212 are used for generating a start input command and an end input command corresponding to user input. The actuators 212 may be buttons arranged on the communication device 20, or menu items displayed on the communication device 20.

When the actuators 212 generates the start input command, the instruction transmitting unit 216 is used for reading the start instruction from the memory 210, and transmitting the start instruction to television 10. At the same time, the communication unit 202 communicates with the another communication device. Furthermore, the communication signal transmitting unit 206 transmits the communication signals to the television 10.

When the actuators 212 generates the end input command, the instruction transmitting unit 216 is used for reading the end instruction from the memory 210, and transmitting the end instruction to television 10. At the same time, the communication unit 202 disconnects a communication between the communication unit 202 and the another communication device.

A television 10, in accordance with the second embodiment, further includes an instruction receiving unit 112 connected with the processor 106 and the communication signal receiving unit 104.

The instruction receiving unit 112 is used for receiving the start instruction and the end instruction transmitted by the instruction transmitting unit 216, and transmitting the start instruction and the end instruction to the processor 106 and the communication signal receiving unit 104. When the instruction receiving unit 112 receives the start instruction, if the television 10 is closed, the processor 106 may respond to the start instruction to open the television 10. At the same time, the communication signal receiving unit 104 responds to the start instruction to receive the communication signals from the communication signal transmitting unit 206. When the instruction receiving unit 112 receives the end instruction, the processor 106 may respond to the end instruction to close the television 10, or reproduce the TV signals. The communication signal receiving unit 104 responds to the end instruction to stop receiving the communication signals from the communication signal transmitting unit 206.

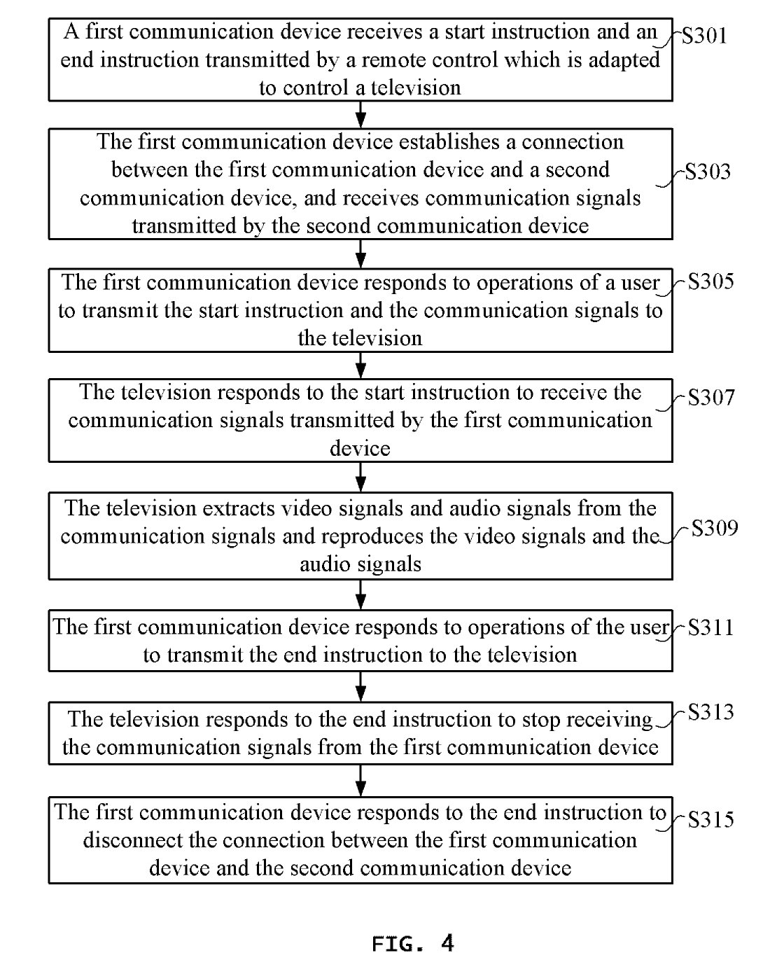

Referring to FIG. 4, a communication method includes following steps.

In step S301, a first communication device receives a start instruction and an end instruction transmitted by a remote control which is adapted to control a television.

In step S303, the first communication device establishes a connection between the first communication device and a second communication device, and receives communication signals transmitted by the second communication device.

In step S305, the first communication device responds to operations of a user to transmit the start instruction and the communication signals to the television.

In step S307, the television responds to the start instruction to receive the communication signals transmitted by the first communication device.

In step S309, the television extracts video signals and audio signals from the communication signals and reproduces the video signals and the audio signals. At the same time, the television may stop reproducing TV signals. In other embodiments, the television may simultaneously display the video signals and the TV signals in the form of PIP or POP. Therefore, the video signals are outputted via the television. Because a display of the television commonly has a relatively large size, it is convenient for more than one person to view pictures corresponding to the video signals.

In step S311, the first communication device responds to operations of a user to transmit the end instruction to the television.

In step S313, the television responds to the end instruction to stop receiving the communication signals from the first communication device. At the same time, the television may responds to the end instruction to close, or play the TV signals.

In step S305, the first communication device responds to the end instruction to disconnect the connection between the first communication device and the second communication device.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A television, comprising:
a television signal receiving unit configured to receive TV signals;
a communication signal receiving unit configured to receive communication signals from a communication device;
a processor for processing the TV signals to generate first video signals, and extracting second video signals from the communication signals; and
a display unit for displaying the first video signals default;
wherein when the communication signal receiving unit receives the communication signals, the processor controls the display unit to display the second video signals.

2. The television according to claim 1, wherein when the communication signal receiving unit receives the communication signals, the processor controls the display unit to simultaneously display the second video signals and the first video signals in a Picture-in-Picture manner.

3. The television according to claim 1, wherein when the communication signal receiving unit receives the communication signals, the processor control the display unit to simultaneously display the second video signals and the first video signals in a Picture-Out-Picture manner.

4. The television according to claim 1, wherein the television further comprises an instruction receiving unit for receiving a start instruction from the communication device, when the instruction receiving unit receives the start instruction from the communication device, the communication signal receiving unit responds to the start instruction to receive the communication signals from the communication device.

5. The television according to claim 4, wherein when the instruction receiving unit receives the start instruction from the communication device, the processor responds to the start instruction to open the television.

6. The television according to claim 1, wherein the television comprises an instruction receiving unit for receiving an end instruction from the communication device, when the instruction receiving unit receives the end instruction from the communication device, the communication signal receiving unit responds to the end instruction to stop receiving the communication signals from the communication device.

7. The television according to claim 6, wherein when the instruction receiving unit receives the end instruction from the communication device, the processor responds to the end instruction to control the display unit to play the TV signals.

8. The television according to claim 6, wherein when the instruction receiving unit receives the end instruction from the communication device, the processor responds to the end instruction to close the television.

9. The television according to claim 1, wherein the processor also processes the TV signals to generate first audio signals, and extracts second audio signals from the communication signals; the television further comprises a speaker for reproducing the first audio signals default; when the communication signal receiving unit receives the communication signals, the processor controls the speaker to reproduce the second audio signals.

10. A communication device, comprising:
a communication unit for communicating with another communication device, and receiving first communication signals transmitted in a first protocol from the another communication device, the first communication signals being embedded with video signals, the video signals capable of being processed to be embedded in second communication signals transmitted in a second protocol; and
a communication signal transmitting unit configured to transmit the second communication signals embedded with the video signals in the second protocol to a television, for rendering the television to display pictures corresponding to the video signals.

11. The communication device according to claim 10, further comprising:
a receiver configured to receive a start instruction from a remote control which is adapted to control the television;
a memory for storing the start instruction;
an actuator configured to generate a start input command corresponding to user input; and
an instruction transmitting unit for responding to the start input command to read the start instruction from the memory and transmit the start instruction to the television.

12. The communication device according to claim 11, wherein the communication unit responds to the start input command to communicate with the another communication device; the communication signal transmitting unit responds to the start input command to transmit the second communication signals to the television.

13. The communication device according to claim 11, wherein the receiver is an infrared receiver.

14. The communication device according to claim 10, further comprising:
a receiver configured to receive an end instruction from a remote control which is adapted to control the television;
a memory for storing the end instruction;
an actuator configured to generate an end input command corresponding to user input; and
an instruction transmitting unit for responding to the end input command to read the end instruction from the memory and transmit the end instruction to the television.

15. The communication device according to claim 14, wherein the communication unit responds to the end input command to disconnect a communication between the communication unit and the another communication device.

16. A communication method, comprising:
a first communication device establishing a connection with a second communication device;
the first communication device receiving communication signals being embedded with video signals from the second communication device; and
the first communication device transmitting the communication signals to a television for rendering the television to display pictures corresponding to the video signals.

17. The communication method according to claim 16, further comprising:
the television receiving the communication signals from the first communication device; and
the television extracting the video signals from the communication signals and displaying the video signals.

18. The communication method according to claim 17, further comprising:
the first communication device receiving a start instruction transmitted by a remote control which is adapted to the television; and
the first communication device responding to operations of a user to transmit the start instruction to the television;
wherein the television responding to the start instruction to receive the communication signals from the first communication device.

19. The communication method according to claim 17, further comprising:
the first communication device receiving an end instruction transmitted by a remote control which is adapted to control the television; and
the first communication device responding to operations of a user to transmit the end instruction to the television; and
the television responding to the end instruction to stop receiving the communication signals from the first communication device.

20. The communication method according to claim 19, further comprising:
the first communication device responding to the end instruction to disconnection the connection between the first communication device and the second communication device.
